(19) United States
(12) Patent Application Publication
(10) Pub. No.: US 2022/0072944 A1
(43) Pub. Date: Mar. 10, 2022

(54) CLUTCH ACTUATOR

(71) Applicant: VALEO EMBRAYAGES, Amiens Cedex 2 (FR)

(72) Inventor: Guillaume BOIDIN, Cergy Pontoise Cedex (FR)

(73) Assignee: VALEO EMBRAYAGES, Amiens Cedex 2 (FR)

(21) Appl. No.: 17/414,694

(22) PCT Filed: Dec. 11, 2019
(86) PCT No.: PCT/EP2019/084674

§ 371 Date: Jun. 16, 2021

(30) Foreign Application Priority Data
Dec. 19, 2018 (FR) 1873416
Dec. 19, 2018 (FR) 1873418

(51) Int. Cl. B60K 6/387; F16D 23/12; F16D 28/00; F16D 29/00

(52) U.S. Cl. CPC B60K 6/387; F16D 23/12; F16D 2023/123; F16D 29/005; B60Y 2200/92; F16D 28/00

(57) ABSTRACT

An actuator for a mobility device clutch includes an electric motor, a roto-linear movement conversion mechanism coupled to the electric motor, a hydraulic unit in the form of an emitter cylinder able to actuate the clutch, and a cam system able to slide linearly in a direction of movement. The cam system includes at least one cam track in connection with the roto-linear movement conversion mechanism in order to generate a thrust force toward the hydraulic unit. The cam track includes at least one first portion and one second portion, the first portion being a docking portion separate from the second portion that is a travel portion, and these two portions having a different profile.

The present invention relates to a clutch actuator, in particular for a transmission system of a mobility device, in particular of a motor vehicle.

The invention applies in particular, but not exclusively, to the actuation of a clutch whose state at rest can be normally engaged or normally disengaged.

The clutch actuator makes it possible to pass from an engaged state, in which the clutch allows the transmission of a torque or of a movement, to a disengaged state, in which such a transmission is not performed, and vice versa. The clutch actuator also makes it possible to retain the clutch in the engaged or disengaged state.

The invention is of particular advantage for the actuation of a clutch of a transmission for a vehicle having a manual or automatic gearbox and equipped with or without a clutch pedal. The actuator according to the invention makes it possible to carry out the freewheeling function, a function more commonly known by the term “coasting”, that is to say a function making it possible to decouple the combustion engine from the rest of the transmission when this combustion engine is not loaded, the aim being to save on fuel.

The invention can also apply to the actuation of a clutch for coupling between a combustion engine and an electric machine when the latter form part of a propulsion chain of a hybrid vehicle. Specifically, there is a need to decouple the combustion engine from the electric machine during long periods, for example when the vehicle is propelled only by the energy of the electric machine.

For these applications, the problem arises of retaining the clutch in the disengaged state or in the engaged state (depending on the open or closed clutch type) in order to decouple the combustion engine from the rest of the transmission. In particular, when using an actuator of a coupling clutch in a hybrid vehicle propulsion chain, it is sought for all the energy provided by the electric machine to be transferred to the wheels without driving the combustion engine, which could generate losses.

There is also a need, in particular for reasons of safety when a failure occurs, to retain the actuator, where appropriate after having brought it there, in the engaged state or in the disengaged state. The clutch of course has a stable state which corresponds, for the actuator, to the one state among the engaged state and the disengaged state. A retention of the actuator in the other state among the engaged state and the disengaged state is then desirable.

For these needs, an electrical retention is possible via a control of the electric motor of the actuator. Nevertheless, such an electrical retention requires the consumption of electrical energy by the actuator, which goes against the current concern of reducing electrical energy consumption, and which produces over a long period a heating of the electric motor of the actuator and requires an oversizing of the latter.

There is thus a need to minimize the consumption of the electric motor without it thereby being zero, since safety reasons dictate that, for example when an electric failure occurs, the clutch can return to the engaged state or to the disengaged state.

There is also a need for an actuator for a clutch of a vehicle transmission chain that is simple to implement and does not consume much energy.

Document US 2016/0305494 A1 describes a clutch actuator able to modify the state of a clutch in order to pass from an engaged state to a disengaged state, and vice versa. The actuator of this document makes it possible to reduce the electrical consumption during the freewheeling phases, which may be long. The actuator describes an electric motor driving a worm wheel system and a rotary cam connected to the wheel, this cam making it possible to actuate a piston of a hydraulic emitter. A recessed shape situated on the cam track makes it possible to stabilize the actuator in position.

This actuator architecture has the disadvantage of using a tangent worm wheel system whose efficiency is mediocre. The shape of the cam is also complex to realize and is not simple to standardize.

The invention aims, at least in part, to meet said needs.

It achieves this, according to a first aspect, by means of an actuator for a mobility device, in particular a motor vehicle, clutch, the actuator comprising an electric motor, a roto-linear movement conversion mechanism coupled to the electric motor, a hydraulic unit in the form of an emitter cylinder able to actuate the clutch, a cam system able to slide linearly in a direction of movement, the cam system comprising at least one cam track in connection with the roto-linear movement conversion mechanism in order to generate a thrust force toward the hydraulic unit, the cam track comprising at least one first portion and one second portion, the first portion being separate from the second portion, and these two portions having a different profile.

Within the sense of the invention, “different profile” means that the two portions have different inclinations, different slopes or different radii of curvature. In other words, “different profile” means that the cam track of the cam system has a variable profile.

According to another aspect, the invention is targeted to an actuator for a mobility device, in particular a motor vehicle clutch, the actuator comprising an electric motor, a roto-linear movement conversion mechanism coupled to the electric motor, a hydraulic unit in the form of an emitter cylinder able to actuate the clutch, a cam system able to slide linearly in a direction of movement, the cam system comprising at least one cam track in connection with the roto-linear movement conversion mechanism in order to generate a thrust force toward the hydraulic unit, the cam track comprising at least one first portion whose surface is substantially planar and substantially perpendicular to the direction of movement of the cam system.

By virtue of the actuator according to the invention, it is thus possible to retain the clutch in the engaged state or in the disengaged state and to do so without supplying the motor with current. This considerably reduces the electrical consumption of the actuator and while ensuring optimal safety. The invention thus makes it possible to reduce the size of the electric motor of the actuator, to avoid possible overheating and to reduce the overall weight of the actuator.

According to another aspect of the invention, the cam track of the cam system comprises at least one second portion whose surface is inclined with respect to the surface of the first portion. In the context of the present invention, the second portion of the cam track is termed “travel portion” and the first portion of the cam track is termed “retaining portion”. When the rolling member of the roto-linear movement conversion mechanism is situated on the first portion of the cam track, the actuator is in a stable or virtually stable position that requires only a small supply of current to the electric motor in order to retain the cam system in this position. It is in particular thus possible to cut the electrical supply.

The actuator according to the invention also allows better control of the disengaged position, thereby reducing noise and shocks in the cam system.

In the context of the present invention, the second portion of the cam track is termed “travel portion”.

According to a particular embodiment according to the first aspect of the invention, the first portion of the cam track is termed “docking portion”.

According to another embodiment according to the second aspect of the invention, the first portion of the cam track is termed “retaining portion”.

According to one feature of the invention, the surface of the first retaining portion of the cam track is substantially planar and parallel to the axis X of extension of the roto-linear movement conversion mechanism.

The terms “substantially planar and substantially perpendicular” of the retaining portion of the cam track mean, within the sense of the invention, that the surface of the first retaining portion of the cam track is for example inclined by plus or minus five degrees (+/−5°) with respect to the axis X.

According to one particular feature of the invention, the two portions of the cam track are straight lines or curves.

The roto-linear movement conversion mechanism coupled to the electric motor forms in particular a part of the actuator separate from the cam system.

By virtue of the design of the cam system, the actuator is particularly silent. It is perfectly integrated into a hybrid vehicle environment and has a good efficiency.

Within the sense of the present application, the clutch with which the actuator interacts is in the completely engaged state when the actuator is in the engaged state, and the clutch is in the completely disengaged state when the actuator is in the disengaged state.

The clutch with which the actuator above interacts is preferably normally closed, that is to say that it has a stable state which is the engaged state.

“Axially” will be understood below as meaning “parallel to the longitudinal axis of extent of the roto-linear movement conversion mechanism”. “Radially” will be understood below as meaning “parallel to the direction of movement of the cam system”.

According to one particular feature of the invention, the two portions have substantially planar surfaces inclined with respect to one another. The surface of the second portion of the cam track is inclined by 175° to 120° with respect to the surface of the first portion of the cam track.

According to the invention, the surface of the second portion of the cam track is in particular 1.5 to 2 times longer than the surface of the first portion of the cam track.

According to the invention, the electric motor comprises a rotary shaft extending along an axis X, and the roto-linear movement conversion mechanism also extends along this same axis X.

According to a variant embodiment, the axis of the rotary shaft of the electric motor and the axis of the roto-linear movement conversion mechanism are parallel. This is the case when a reduction mechanism (gears, chain, belt, etc.) is situated between the rotary shaft of the electric motor and the roto-linear movement conversion mechanism.

According to the invention, the angle of inclination of the first docking or retaining portion with respect to the axis X is smaller than the angle of inclination of the second travel portion with respect to the axis X. More precisely, the angle of inclination of the first docking or retaining portion with respect to the axis X is at least 1.25 times smaller than the angle of inclination of the second travel portion with respect to the axis X. The angle of inclination of the first docking or retaining portion with respect to the axis X is between 15° and 65°. The angle of inclination of the second travel portion with respect to the axis X is between 5° and 45°.

According to one additional feature of the invention, the hydraulic unit extends along an axis Y which is perpendicular to the axis X of extension of the electric motor and of the roto-linear movement conversion mechanism.

According to the invention, the direction of movement of the cam system is parallel to the axis Y of extension of the hydraulic unit.

According to another particular feature of the invention, the cam system is arranged between the roto-linear movement conversion mechanism and the hydraulic unit. The roto-linear movement conversion mechanism and the cam system thus convert the rotational movement about the axis X of the electric motor into a translational movement along the axis Y.

According to one aspect of the invention, the roto-linear movement conversion mechanism and the cam system are housed in a housing to which the electric motor and the hydraulic unit are fastened.

According to another particular feature of the invention, the roto-linear movement conversion mechanism is a screw/nut system. In an advantageous manner, balls are arranged between the screw and the nut in order to form a ball screw system and thus reduce the friction between the screw and the nut, thereby making it possible to increase the efficiency of the mechanism.

According to one aspect of the invention, the nut of the roto-linear movement conversion mechanism comprises at least one rolling member in contact with the cam track of the cam system. The rolling member thus performs the function of a cam follower.

The nut of the roto-linear movement conversion mechanism comprises another rolling member which is in contact with the housing in order to ensure the translational movement of the nut. An additional bearing surface can be arranged between the rolling member and the housing. These rolling members associated with the nut are separate and may be concentric.

According to the invention, the surface of the second travel portion of the cam track is inclined by 175° to 115° with respect to the surface of the first portion, i.e. the docking portion or, respectively retaining portion of the cam track.

According to one feature of the invention, the cam system comprises at least one first rolling element and one second rolling element allowing its linear movement in the housing in the direction of movement. The housing comprises at least one first bearing surface able to cooperate with the first rolling element and one second bearing surface able to cooperate with the second rolling element. The two bearing surfaces are situated on separate walls of the housing. In a variant, the two bearing surfaces are situated on the same walls of the housing.

According to the invention, the bearing surfaces take the form of an additional plate made of optimized material, for example hard steel, in order to increase the resistance to the contact pressure of the rolling elements or of the rolling members and thus to reduce friction and noise.

According to one example of the invention, the first docking or retaining portion of the cam system is situated radially below the rolling elements of the cam system.

In an advantageous manner, the first docking or retaining portion of the cam system is situated axially close to the electric motor.

According to the invention, the housing comprises a first volume and a second volume. The first volume houses the roto-linear movement conversion mechanism and the part of the cam system having the cam track, and the second volume houses the part of the cam system having the rolling elements allowing the linear movement of the cam system in the housing. From a subassembly point of view, the first volume houses the roto-linear movement conversion mechanism, which is movable along the axis X, and the second volume houses the cam system, which is movable in the direction of movement parallel to the axis Y.

According to another feature of the invention, the hydraulic unit comprises a piston for moving a volume of hydraulic fluid. The hydraulic unit also comprises a movement sensor in order to detect the linear position of the piston in the hydraulic unit. This sensor is an absolute position sensor.

According to the invention, the cam system comprises in particular a tappet able to transmit the thrust force generated by the cam system to the hydraulic unit. The piston of the hydraulic unit is in contact with the tappet of the cam system.

According to one aspect of the invention, the piston of the hydraulic unit is movable along the axis Y. In other words, the piston of the hydraulic unit is movable in a direction parallel to the direction of movement of the cam system.

According to an additional aspect of the invention, the piston of the hydraulic unit is returned toward the rear by a return spring housed in the hydraulic unit.

The piston returned “toward the rear” will be understood below as meaning the actuator in its engaged state, that is to say that the piston moves toward the axis X. The piston returned “toward the front” will be understood below as meaning the actuator in its disengaged state, that is to say that the piston moves away from the axis X.

According to another feature of the invention, the hydraulic unit comprises a high-pressure connection region serving to connect a duct for fluidically connecting the hydraulic unit to a receiving cylinder associated with the clutch. The hydraulic unit also comprises a low-pressure connection region in fluidic communication with a low-pressure reservoir.

According to the invention, the movement of the piston in the hydraulic unit causes the movement of a volume of hydraulic fluid in the duct, for example oil, so as to actuate the receiving cylinder, itself able to actuate the clutch. The clutch actuator is of the hydrostatic type, that is to say that it allows the movement of a volume of hydraulic fluid without however generating a flow of hydraulic fluid, the volume of fluid remaining in effect virtually unchanged over time.

Another subject of the present invention is a mobility device clutch system, in particular a motor vehicle clutch system, said clutch system comprising an actuator according to the aforementioned features, a clutch, a receiving cylinder associated with the clutch, and a hydraulic duct arranged between the actuator and the receiving cylinder.

Another subject of the present invention is a transmission system for a mobility device, for example a motor vehicle, in particular a hybrid vehicle, the transmission system comprising a combustion engine, a gearbox, possibly an electric machine, and a clutch system according to the aforementioned features, the clutch being arranged between the combustion engine and the gearbox or the electric machine.

The invention will be better understood, and other aims, details, features and advantages thereof will become clearer, from the following description of particular embodiments of the invention, which are given purely by way of illustration and in a nonlimiting manner with reference to the appended figures.

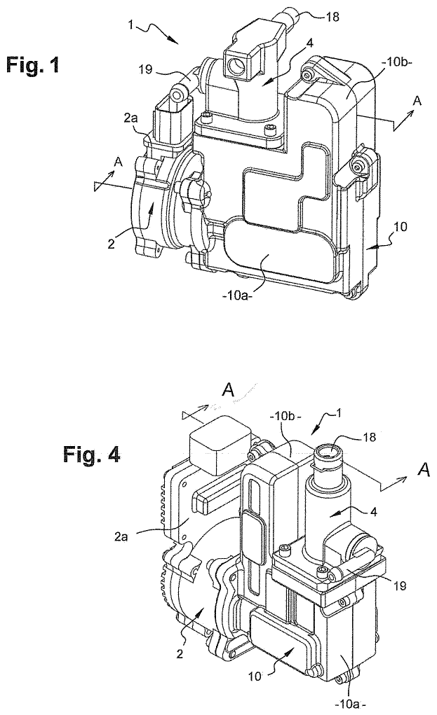

FIG. 1 represents a perspective view of a clutch actuator according to a first embodiment of the invention.

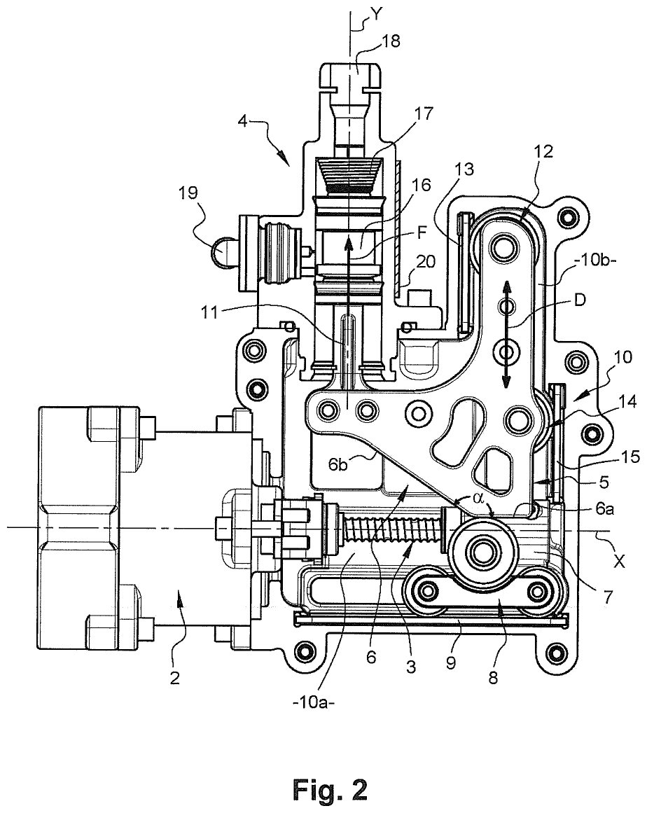

FIG. 2 represents a view in section A-A of a second embodiment of the invention in a disengaged state.

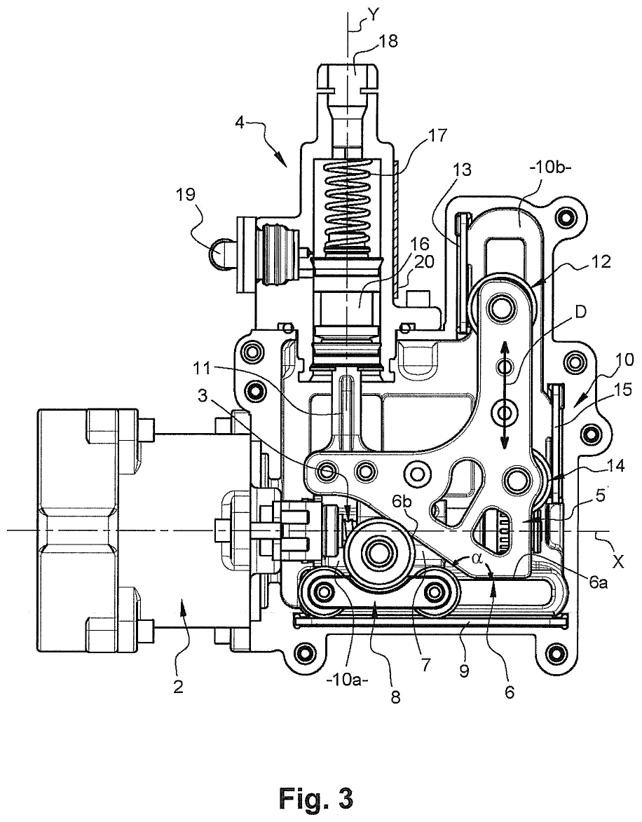

FIG. 3 represents a view in section A-A of the embodiment of FIG. 2 in an engaged state.

FIG. 4 represents a perspective view of a clutch actuator according to a second embodiment of the invention.

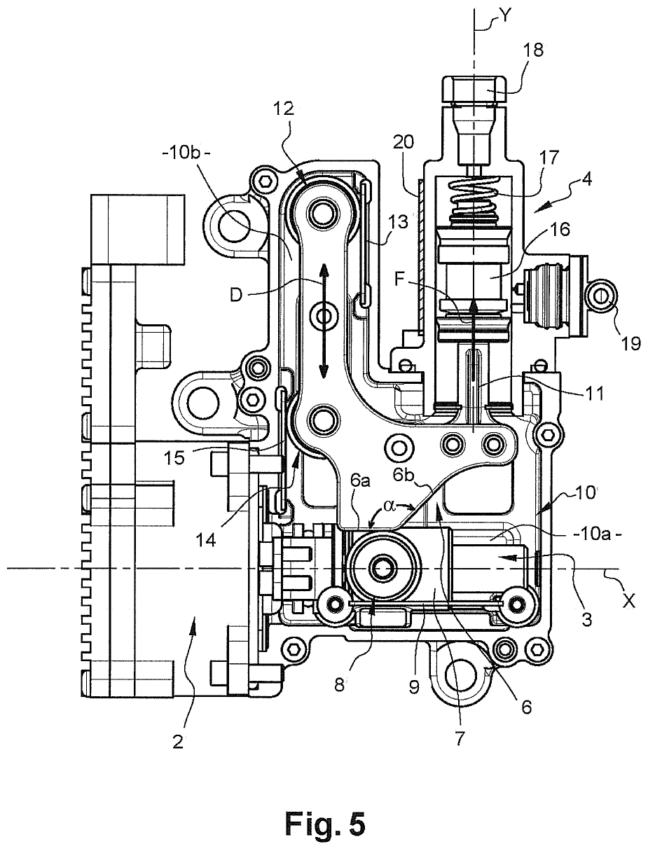

FIG. 5 represents a view in section A-A of a second embodiment of the invention in a disengaged state.

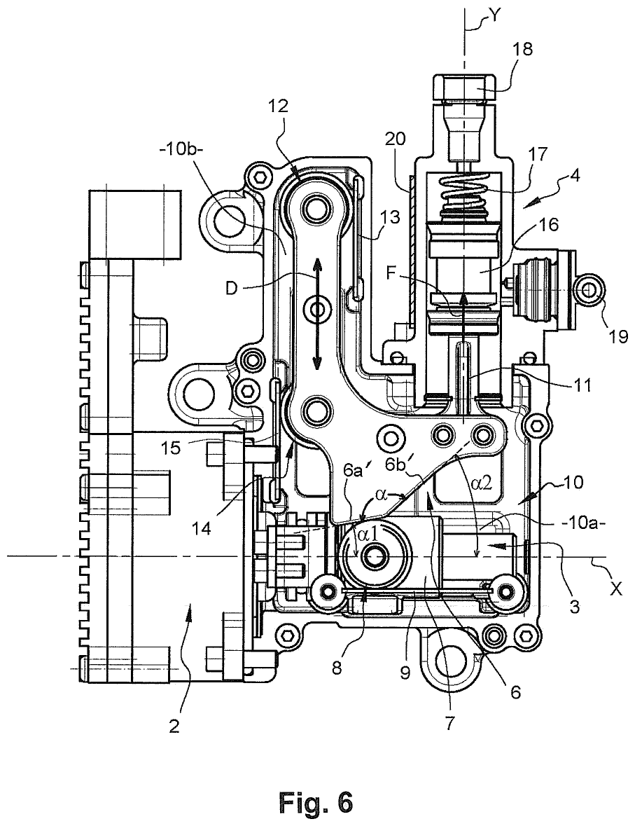

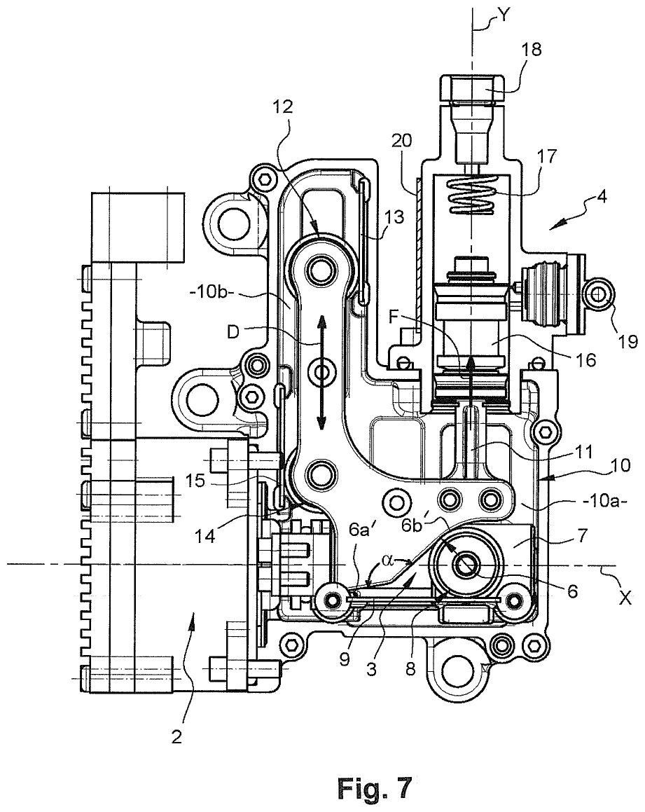

FIG. 6 and FIG. 7 represents views in section A-A of a variant of the embodiment of FIG. 4 in respectively a disengaged state and an engaged state.

FIG. 1 depicts a clutch actuator 1 configured to actuate a clutch (not shown) in order to pass it from an engaged state to a disengaged state, or vice versa. This clutch can be a dry or wet single or double clutch and be of the normally closed or normally open type. Within the scope of the invention, the clutch is in particular single and of the normally closed type.

This clutch actuator 1 comprises an electric motor 2 housed in a shell, a housing 10 receiving a roto-linear movement conversion mechanism and a cam system (which are not shown in FIG. 1) and a hydraulic unit 4 in the form of an emitter cylinder.

The electric motor 2 is a brushless permanent magnet motor. It comprises a housing 2a able to receive an electronic card serving to control the electric motor 2.

The housing 10 is composed of two half-shells 10a, 10b connected to one another by fastening means such as screws. The housing 10 comprises a first volume 10a and a second volume 10b. The functionality of these volumes will be described in relation to the following figures. The housing 10 is made of a plastic or metallic material.

The hydraulic unit 4 comprises a high-pressure connection region 18 serving to connect a duct for fluidically connecting the hydraulic unit 4 to a receiving cylinder associated with the clutch (which are not shown in FIG. 1). The hydraulic unit 4 also comprises a low-pressure connection region 19 in fluidic communication with a low-pressure reservoir (not shown in FIG. 1).

The electric motor 2 and the hydraulic unit 4 are fastened to the housing 10 by fastening means such as screws. A tightness seal can be provided between the electric motor 2 and the housing 10 and between the hydraulic unit 4 and the housing 10. In the embodiment of FIG. 1, the hydraulic unit 4 is situated substantially between the electric motor 2 and the second volume 10b of the housing 10.

The hydraulic unit 4 is situated at one end of the actuator 1, this being advantageous for accessibility to this hydraulic unit 4, which requires manipulations, in particular purge manipulations.

The clutch actuator 1 can be fastened, for example, to a casing of a gearbox, for example via a support (not shown in FIG. 1).

FIG. 2 depicts the clutch actuator 1 according to the first embodiment and in a disengaged state. In this FIG. 2, one half-shell of the housing 10 has been removed in order to reveal the interior of this housing 10 and more precisely the roto-linear movement conversion mechanism 3 and the cam system 5. In this FIG. 3, the hydraulic unit 4 is shown in section in order to reveal the piston 16 and the way in which it cooperates with the cam system 5.

The electric motor 2 comprises a rotary shaft extending along an axis X. This rotary shaft, which corresponds to the output shaft of the electric motor 2, is directly connected to the roto-linear movement conversion mechanism 3 which extends along this same axis X. In a variant (not shown), a reduction mechanism can be arranged between the rotary shaft of the electric motor 2 and the roto-linear movement conversion mechanism 3.

The roto-linear movement conversion mechanism 3 is a screw/nut system 7 in which balls are arranged between the screw and the nut 7 in order to form a ball screw system. The nut 7 of the roto-linear movement conversion mechanism 3 comprises at least one rolling member 8. The rolling member 8 cooperates with the cam system 5. Another concentric and separate rolling member 8 cooperates with a guide surface 9 of the housing 10. The nut 7 and the rolling member 8 are thus able to move translationally along the axis X when the electric motor 2 is in operation.

The cam system 5 is able to slide linearly in a direction of movement D in the housing 10. The cam system 5 comprises at least one first rolling element 12 and one second rolling element 14 allowing its linear movement in the housing 10 in the direction of movement D. The housing 10 comprises at least one first bearing surface 13 able to cooperate with the first rolling element 12 and one second bearing surface 15 able to cooperate with the second rolling element 14.

The two bearing surfaces 13, 15 and the guide surface 9 are situated on separate walls of the housing 10. The bearing surfaces 13, 15 and the guide surface 9 take the form of additional plates made of optimized material in order to reduce friction and noise.

The housing 10 comprises a first volume 10a and a second volume 10b, the first volume 10a housing the roto-linear movement conversion mechanism 3 and the part of the cam system 5 having the cam track 6. The second volume 10b houses the part of the cam system 5 having the rolling elements 12, 14 allowing the linear movement of the cam system 6 in the housing 10.

The cam system 5 comprises at least one cam track 6 in connection with the roto-linear movement conversion mechanism 3, more particularly the rolling member 8. The rolling member 8 thus performs the function of a cam follower.

The cam track 6 comprises a first portion 6a and a second portion 6b whose surface is inclined with respect to the surface of the first portion 6a. For example, the surface of the second travel portion 6b of the cam track 6 is inclined by an angle α of 175° to 115 or of 175° to 120° with respect to the surface of the first portion 6a of the cam track 6. The second portion 6b of the cam track 6 is termed “travel portion”. According to this embodiment the first portion 6a of the cam track 6 is termed “retaining portion”.

The surface of the first portion 6a of the cam track 6 is substantially planar. In this embodiment of the figure, this retaining portion 6a is perpendicular to the direction of movement D of the cam system.

The surface of the first portion 6a of the cam track 6 is substantially planar and parallel to the axis X of extension of the roto-linear movement conversion mechanism 3.

The hydraulic unit 4 extends at the top part of the actuator 1. This hydraulic unit 4 extends along an axis Y which is perpendicular to the axis X of extension of the electric motor 2 and of the roto-linear movement conversion mechanism 3. The direction of movement D of the cam system 5 is parallel to the axis Y of extension of the hydraulic unit 4.

The hydraulic unit 4 comprises a piston 16 for moving a volume of hydraulic fluid. The piston 16 of the hydraulic unit 4 is movable along the axis Y. In other words, the piston 16 of the hydraulic unit 4 is movable in a direction parallel to the direction of movement D of the cam system 5. The piston 16 of the hydraulic unit 4 is in contact with a tappet 11 of the cam system 5 that takes the form of a pin. The tappet 11 serves to transmit the thrust force F generated by the cam system 5 to the hydraulic unit 4. The piston 16 of the hydraulic unit 4 is returned toward the rear by a return spring 17 housed in the hydraulic unit 4. The cam system 5 is thus arranged between the roto-linear movement conversion mechanism 3 and the hydraulic unit 4.

The hydraulic unit 4 also comprises a movement sensor 20 in order to detect the linear position of the piston 16 in the hydraulic unit 4. This sensor 20 makes it possible to provide information for powering the electric motor 2.

During operation, the electric motor 2 is controlled by means of the electronic card, driving the rotation of the rotary shaft and of the roto-linear movement conversion mechanism 3.

When the rolling member 8 of the roto-linear movement conversion mechanism 3 is situated on the retaining portion 6a of the cam track 6, the actuator 1 is in a stable position, and it is thus possible to cut the electrical supply of the electric motor 2.

The speed of translation of the nut 7 of the roto-linear movement conversion mechanism 3 is dependent on the speed of rotation of the electric motor 2.

By virtue of the rolling member 8, which is in contact with the cam track 6 of the cam system 5, the roto-linear movement conversion mechanism 3 and the cam system 5 thus convert the rotational movement about the axis X of the electric motor 2 into a translational movement along the axis Y.

When the nut 7 of the roto-linear movement conversion mechanism 3 is situated in a position close to the electric motor 2, the associated rolling member 8 is in contact with the second travel portion 6b of the cam track 6′. The cam system 5 then moves linearly in the housing 10 in the direction of movement D and thus allows the movement of the piston 16 in the hydraulic unit 4 in order to vary the state of the clutch.

The distance and the speed of the linear movement D of the cam system is dependent on the slope of the curve defined by the second travel portion 6b of the cam track 6. This curve can be, at least partly, a straight line, as is the case in illustrated embodiments of the invention.

When the nut 7 of the roto-linear movement conversion mechanism 3 is situated in a position moved away from the electric motor 2, as is the case in FIG. 3, the associated rolling member 8 is in contact with the first portion 6a of the cam track 6. In this position, on account of the planar surface perpendicular to the direction of movement D of the cam system 5, the cam system 5 can no longer move translationally, even under the effect of the spring 17 of the hydraulic unit. The embodiment of the invention with a retaining portion takes on its full significance here, since it is thus possible to cut the electrical supply of the electric motor 2 and the clutch will remain in a stable position which, in the case of FIG. 4, is a disengaged position.

FIG. 3 depicts the clutch actuator 1 according to the first embodiment and in an engaged state. Unlike in FIG. 2, the rolling member 8 of the roto-linear movement conversion mechanism 3 is in contact with the second travel portion 6b of the cam track 6. In this configuration, the actuator 1 allows the change of state of the clutch on account of the inclination of the second travel portion 6b of the cam track 6.

FIG. 4 depicts a second embodiment of the clutch actuator 1. All the numerical references of the elements common to FIG. 1 are adopted.

The clutch actuator 1 of FIG. 4 is substantially identical to the clutch actuator 1 of FIG. 1 but differs in terms of the shape of the housing 10. In the embodiment of FIG. 4, the second volume 10b of the housing 10 is situated substantially between the electric motor 2 and the hydraulic unit 4. This arrangement has the advantage of positioning the hydraulic unit 4 at one end of the actuator 1, this being advantageous for accessibility to this hydraulic unit 4, which requires manipulations, in particular purge manipulations.

FIG. 5 depicts the clutch actuator 1 according to the second embodiment and in a disengaged state. In this second embodiment, the housing 10 and the cam system 5 have different positions. The second volume 10b of the housing 10 is situated substantially between the electric motor 2 and the hydraulic unit 4.

To this end, when the nut 7 of the roto-linear movement conversion mechanism 3 is situated in a position close to the electric motor 2, the associated rolling member 8 is in contact with the first portion i.e. retaining portion 6a of the cam track 6, which is the planar surface perpendicular to the direction of movement D of the cam system 5. It is thus possible to cut the electrical supply of the electric motor 2 in this position.

When the nut 7 of the roto-linear movement conversion mechanism 3 is situated in a position moved away from the electric motor 2, the associated rolling member 8 is in contact with the second travel portion 6b of the cam track 6. The cam system 5 then moves linearly in the housing 10 in the direction of movement D and thus allows the movement of the piston 16 in the hydraulic unit 4 in order to vary the state of the clutch.

FIG. 6 depicts the clutch actuator 1 according to variant of the second embodiment and in a disengaged state. In the illustrated example of FIG. 6, the cam track 6 comprises a first portion 6a′ and a second portion 6b′ whose surface is inclined with respect to the surface of the first portion 6a′. For example, the surface of the second travel portion 6b′ of the cam track 6 is inclined by an angle α of 175° to 115 or of 175° to 120° with respect to the surface of the first portion 6a′ of the cam track 6. The second portion 6b′ of the cam track 6 is termed “travel portion”. According to this embodiment the first portion 6a′of the cam track 6 is termed “docking portion”.

The surface of the docking portion 6a′ of the cam track 6 is substantially planar. It is inclined by an angle α1 with respect to the axis X. This angle of inclination α1 is between 5° and 45°.

The surface of the travel portion 6b′ of the cam track 6 is substantially planar and is inclined by an angle α2 with respect to the axis X. This angle of inclination α2 is between 15° and 65°.

The hydraulic unit 4 extends at the top part of the actuator 1. This hydraulic unit 4 extends along an axis Y which is perpendicular to the axis X of extension of the electric motor 2 and of the roto-linear movement conversion mechanism 3. The direction of movement D of the cam system 5 is parallel to the axis Y of extension of the hydraulic unit 4.

The hydraulic unit 4 comprises a piston 16 for moving a volume of hydraulic fluid. The piston 16 of the hydraulic unit 4 is movable along the axis Y. In other words, the piston 16 of the hydraulic unit 4 is movable in a direction parallel to the direction of movement D of the cam system 5. The piston 16 of the hydraulic unit 4 is in contact with a tappet 11 of the cam system 5 that takes the form of a pin. The tappet 11 serves to transmit the thrust force F generated by the cam system 5 to the hydraulic unit 4. The piston 16 of the hydraulic unit 4 is returned toward the rear by a return spring 17 housed in the hydraulic unit 4. The cam system 5 is thus arranged between the roto-linear movement conversion mechanism 3 and the hydraulic unit 4.

The hydraulic unit 4 also comprises a movement sensor 20 in order to detect the linear position of the piston 16 in the hydraulic unit 4. This sensor 20 makes it possible to provide information for powering the electric motor 2.

During operation, the electric motor 2 is controlled by means of the electronic card, driving the rotation of the rotary shaft and of the roto-linear movement conversion mechanism 3.

When the rolling member 8 of the roto-linear movement conversion mechanism 3 is situated on the first portion 6a′ of the cam track 6, the actuator 1 is in a stable position. By virtue of the angle of inclination α1 of the surface of the first docking portion 6a′ of the cam track 6, the force to be provided (in terms of torque) by the electric motor 2 to retain the actuator 1 in this position is reduced.

The speed of translation of the nut 7 of the roto-linear movement conversion mechanism 3 is dependent on the speed of rotation of the electric motor 2.

By virtue of the rolling member 8, which is in contact with the cam track 6 of the cam system 5, the roto-linear movement conversion mechanism 3 and the cam system 5 thus convert the rotational movement about the axis X of the electric motor 2 into a translational movement along the axis Y.

When the nut 7 of the roto-linear movement conversion mechanism 3 is situated in a position close to the electric motor 2, the associated rolling member 8 is in contact with the first docking portion 6a′ of the cam track 6, which is the planar surface inclined by the angle of inclination α1 with respect to the axis X. The clutch is thus in its disengaged state and the retention of the actuator in this position for a long period results in a limited current consumption for the electric motor.

In the event of failure of the electric system of the vehicle in which the actuator is mounted, it will still be possible to pass the clutch into its engaged state on account of the planar surface inclined by the angle of inclination α1 with respect to the axis X, but also by virtue of the return force of the spring 17 and of the hydraulic pressure which tends to return the piston “toward the rear”.

When the nut 7 of the roto-linear movement conversion mechanism 3 is situated in a position moved away from the electric motor 2, the associated rolling member 8 is in contact with the second travel portion 6b′ of the cam track 6. The cam system 5 then moves linearly in the housing 10 in the direction of movement D and thus allows the movement of the piston 16 in the hydraulic unit 4 in order to vary the state of the clutch.

The distance and the speed of the linear movement D of the cam system is dependent on the slope of the curve defined by the second travel portion 6b′ of the cam track 6. This curve can be, at least partly, a straight line.

FIG. 7 depicts the clutch actuator 1 of FIG. 6 in an engaged state. Unlike in FIG. 6, the rolling member 8 of the roto-linear movement conversion mechanism 3 is in contact with the second travel portion 6b′ of the cam track 6. In this configuration, the actuator 1 allows the change of state of the clutch on account of the inclination of the second travel portion 6b′ of the cam track 6.

1. An actuator for a mobility device clutch, the actuator comprising an electric motor, a roto-linear movement conversion mechanism coupled to the electric motor, a hydraulic unit in the form of an emitter cylinder able to actuate the clutch, a cam system able to slide linearly in a direction of movement, the cam system comprising at least one cam track in connection with the roto-linear movement conversion mechanism in order to generate a thrust force toward the hydraulic unit, wherein the cam track comprises at least one first portion and one second portion, the first portion being a docking portion separate from the second portion that is a travel portion, and these two portions having a different profile.

2. The actuator as claimed in claim 1, wherein the first retaining portion and the second travel portion have substantially planar surfaces inclined with respect to one another.

3. An actuator for a mobility device clutch, the actuator comprising an electric motor, a roto-linear movement conversion mechanism coupled to the electric motor, a hydraulic unit in the form of an emitter cylinder able to actuate the clutch, a cam system able to slide linearly in a direction of movement, the cam system comprising at least one cam track in connection with the roto-linear movement conversion mechanism in order to generate a thrust force toward the hydraulic unit, wherein the cam track comprises at least one first portion that is a retaining portion, wherein a surface of said retaining portion is substantially planar and substantially perpendicular to the direction of movement of the cam system.

4. The actuator as claimed in claim 3, wherein the cam track of the cam system comprises at least one second travel portion whose surface is inclined with respect to the surface of the first retaining portion.

5. The actuator as claimed in claim 1, wherein the electric motor comprises a rotary shaft extending along an axis X, and in that the roto-linear movement conversion mechanism also extends along this same axis X.

6. The actuator as claimed in the claim 5, wherein the angle of inclination of the first docking or retaining portion with respect to the axis X is smaller than the angle of inclination of the second travel portion with respect to the axis X, in particular at least 1.25 times smaller than the angle of inclination of the second travel portion with respect to the axis X.

7. The actuator as claimed in claim 1, wherein the cam system is arranged between the roto-linear movement conversion mechanism and the hydraulic unit.

8. The actuator as claimed in claim 1, wherein the roto-linear movement conversion mechanism and the cam system are housed in a housing to which the electric motor and the hydraulic unit are fastened.

9. The actuator as claimed in o claim 1, wherein the roto-linear movement conversion mechanism is a screw/nut system.

10. The actuator as claimed in claim 9, wherein the nut of the roto-linear movement conversion mechanism comprises at least one rolling member in contact with the cam track of the cam system and at least one rolling member in contact with a guide surface of the housing.

11. The actuator as claimed in claim 8, wherein the cam system comprises at least one first rolling element and one second rolling element allowing its linear movement in the housing in the direction of movement, the housing comprising at least one first bearing surface able to cooperate with the first rolling element and one second bearing surface able to cooperate with the second rolling element.

12. The actuator as claimed in the preceding claim 11, wherein the first docking or retaining portion of the cam system is situated radially below the rolling elements.

13. The actuator as claimed in claim 11, wherein the housing comprises a first volume and a second volume, the first volume housing the roto-linear movement conversion mechanism and the part of the cam system having the cam track, and the second volume housing the part of the cam system having the rolling elements allowing the linear movement of the cam system in the housing.

14. The actuator as claimed in claim 1, wherein the hydraulic unit comprises a piston for moving a volume of hydraulic fluid, and in that the hydraulic unit also comprises a movement sensor in order to detect the linear position of the piston in the hydraulic unit.

15. A mobility device clutch system comprising an actuator as claimed in claim 1, a clutch, a receiving cylinder associated with the clutch, and a hydraulic duct arranged between the actuator and the receiving cylinder.

16. A transmission system for mobility device, in particular a hybrid vehicle, the transmission system comprising a combustion engine, a gearbox, possibly an electric machine, and a clutch system as claimed in claim 15, the clutch being arranged between the combustion engine and the gearbox or the electric machine.
